(19) United States
(12) Patent Application Publication
(10) Pub. No.: US 2026/0068822 A1
(43) Pub. Date: Mar. 12, 2026

(54) AERATED FLOOR SYSTEM FOR GRAIN BINS

(71) Applicant: SUKUP MANUFACTURING CO., Sheffield, IA (US)

(72) Inventors: Ryan Olson, Dows, IA (US); Randy Marcks, St. Ansgar, IA (US); David Brownmiller, Mason City, IA (US)

(21) Appl. No.: 19/319,948

(22) Filed: Sep. 5, 2025

Related U.S. Application Data
(60) Provisional application No. 63/692,773, filed on Sep. 10, 2024.

(51) Int. Cl. A01F 25/22; B01D 46/00; B01D 46/12; B01D 46/58; B65D 88/74

(52) U.S. Cl. CPC A01F 25/22; B01D 46/0045; B01D 46/12; B01D 46/58; B65D 88/745; B01D 2273/30; B65D 2588/746

(57) ABSTRACT

In one or more arrangements, an aerated floor system for grain bins is presented. The system includes a plurality of planks positioned above one or more airflow passageways. The plurality of planks have a plurality of perforations to facilitate the flow of air through the planks. The system includes one or more filters positioned below the plurality of planks to catch flour, dust, and/or debris that fall through the plurality of perforations of the plurality of planks while permitting air to be moved upward through the one or more filters and the plurality of planks. In this manner, the build-up of flour, dust, and/or debris in the one or more airflow passageways is reduced.

### CROSS-REFERENCE TO RELATED APPLICATIONS

This patent application claims priority to provisional patent application Ser. No. 63/692,773 filed on Sep. 10, 2024, entitled “Aerated Floor System for Grain Bins” which is hereby fully incorporated by reference herein.

### FIELD OF THE DISCLOSURE

This disclosure relates to grain storage devices used in agriculture. More specifically and without limitation, this disclosure relates to flooring for grain bins.

### OVERVIEW OF THE DISCLOSURE

Grain bins are massive structures used to store bulk flowable grain products such as corn, soybeans, wheat, rice, or any other grain products or other material. Conventional grain bins are generally formed in a cylindrical shape with a corrugated sidewall covered by a peaked roof. Grain bins vary in height (ranging from twenty feet high to over a hundred and fifty feet high, or higher). Grain bins vary in diameter, (ranging from eighteen feet in diameter to over a hundred and fifty feet in diameter, or larger). The storage capacity of modern grain bins can range anywhere from a few thousand bushels to well over two million bushels.

Smaller grain bins tend to have an elevated floor formed of a plurality of planks that are supported by a plurality of floor supports that are positioned in spaced alignment to one another. These floor supports rest upon the foundation of the grain bin, which is typically a concrete slab, and provide support to the elevated floor. The space formed between the foundation and the elevated floor facilitates airflow below the elevated floor. Air blown into this space below the elevated floor passes through perforations in the planks of the elevated floor and through the grain stored in the grain bin. In this way, grain stored within the grain bin is conditioned using air flow through the grain. The use of the elevated floor provides many advantages.

Using an elevated floor for larger grain bins becomes problematic due to the immense weight of the grain stored within larger grain bins. As such, in many larger grain bins, the grain sits directly upon the concrete slab that forms the foundation of the grain bin. This arrangement provides the benefit of being strong and rigid. However, this arrangement lacks some of the benefits of an elevated floor, such as airflow through the floor and room beneath the floor for various components.

Grain bins may be unloaded in various ways. Many grain bins include a generally centrally positioned sump that facilitates removal of grain from the grain bin. While this configuration is effective at removing most of the grain from a grain bin, using a centrally positioned sump alone leaves a coned ring of grain that cannot be removed by a centrally positioned sump alone.

To avoid manually shoveling this coned ring of grain out of the grain bin, in many applications sweeps are used. Sweeps travel around the grain bin and help to move grain towards the centrally positioned sump so that the grain may be removed by the sump.

However, in operation of sweeps flour, dust, and/or other fine debris (e.g., created by breaking of grain) may fall through or be pushed through the perforations of the floor and collect in the space below. Over time flour, dust, and/or other fine debris may build up and block airflow through the passageway below the floor. In some larger grain bins, passageways below the floor may be completely filled with flour, dust, and/or other fine debris in less than a year.

Therefore, for all the reasons stated above, and all the reasons stated below, there is a long felt but unsolved need in the art to mitigate the problems caused by flour, dust, and/or other fine debris falling through perforations in the floor of grain bins.

Thus, it is a primary object of the disclosure to provide an aerated floor system for grain bins that improves upon the state of the art.

Another object of the disclosure is to provide an aerated floor system for grain bins that reduces or eliminates the build-up of flour, dust, and/or debris in airflow passageways below an aerated floor of a grain bin.

Yet another object of the disclosure is to provide an aerated floor system for grain bins that works effectively.

Another object of the disclosure is to provide an aerated floor system for grain bins that requires less frequent cleaning.

Yet another object of the disclosure is to provide an aerated floor system for grain bins that is durable.

Another object of the disclosure is to provide an aerated floor system for grain bins that can be used with all kinds of grain.

Yet another object of the disclosure is to provide an aerated floor system for grain bins that has a long useful life.

Another object of the disclosure is to provide an aerated floor system for grain bins that can be used with sweep systems.

Yet another object of the disclosure is to provide an aerated floor system for grain bins that can be used with paddle sweeps, auger sweeps, or any other configuration of a sweep.

These and other objects, features, or advantages of the disclosure will become apparent from the specification, figures and claims.

### SUMMARY OF THE DISCLOSURE:

In one or more arrangements, an aerated floor system for grain bins is presented. The system includes a plurality of planks positioned above one or more airflow passageways. The plurality of planks have a plurality of perforations to facilitate the flow of air through the planks. The system includes one or more filters positioned below the plurality of planks to catch flour, dust, and/or debris that fall through the plurality of perforations of the plurality of planks while permitting air to be moved upward through the one or more filters and the plurality of planks. In this manner, the build-up of flour, dust, and/or debris in the one or more airflow passageways is reduced. In some various arrangements, filters may include: one or more perforated sheets, one or more screens, one or more layers of foam; one or more textile layers, and/or one or more layers of other filter material.

### BRIEF DESCRIPTION OF THE DRAWINGS:

FIG. 1 is an elevation view of a grain bin; the view showing the grain bin having a foundation, a cylindrical sidewall and a peaked roof.

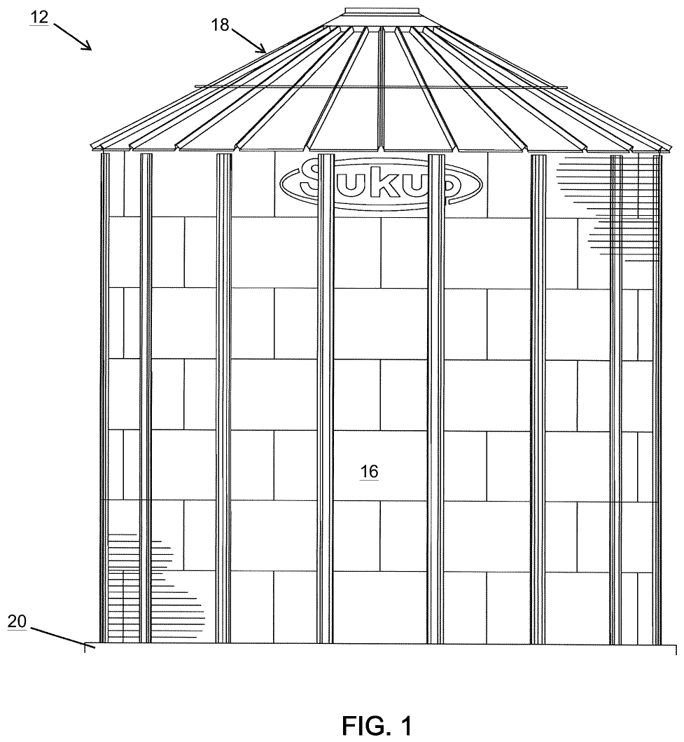

FIG. 2 is a perspective cut-away view of a grain bin with a sweep system; the view showing the grain bin having a sweep system positioned just within the sidewall of the grain bin.

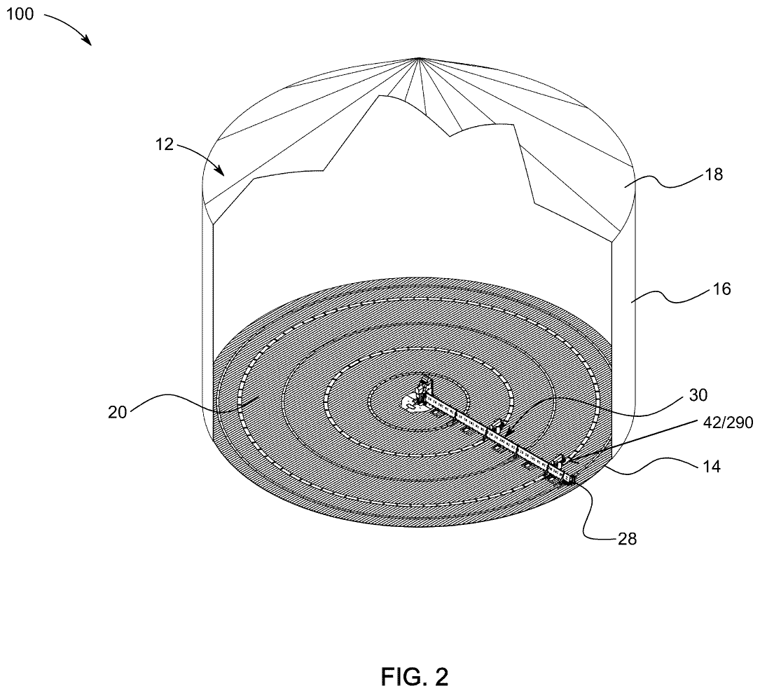

FIG. 3 shows a perspective cut-away elevation view of a grain bin having an aerated floor system, in accordance with one or more arrangements, the view showing a sweep system positioned on top of the elevated floor and just within the sidewall of the grain bin.

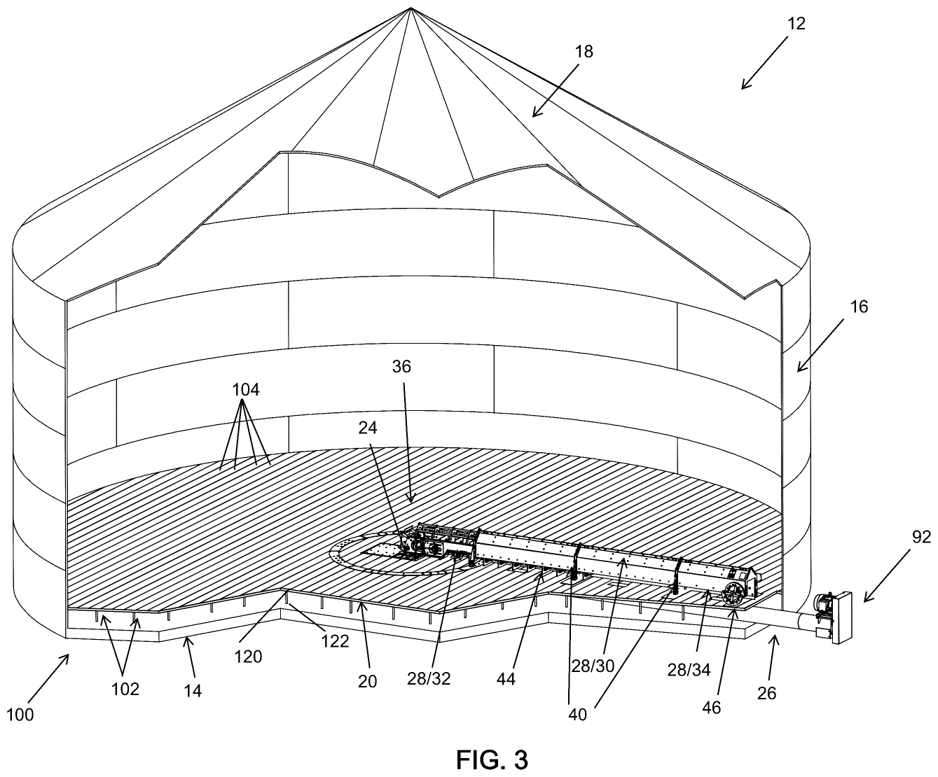

FIG. 4 shows a perspective cut-away elevation view of a grain bin having an aerated floor system, in accordance with one or more arrangements; the view showing a sweep system positioned on top of an elevated floor and just within the sidewall of the grain bin.

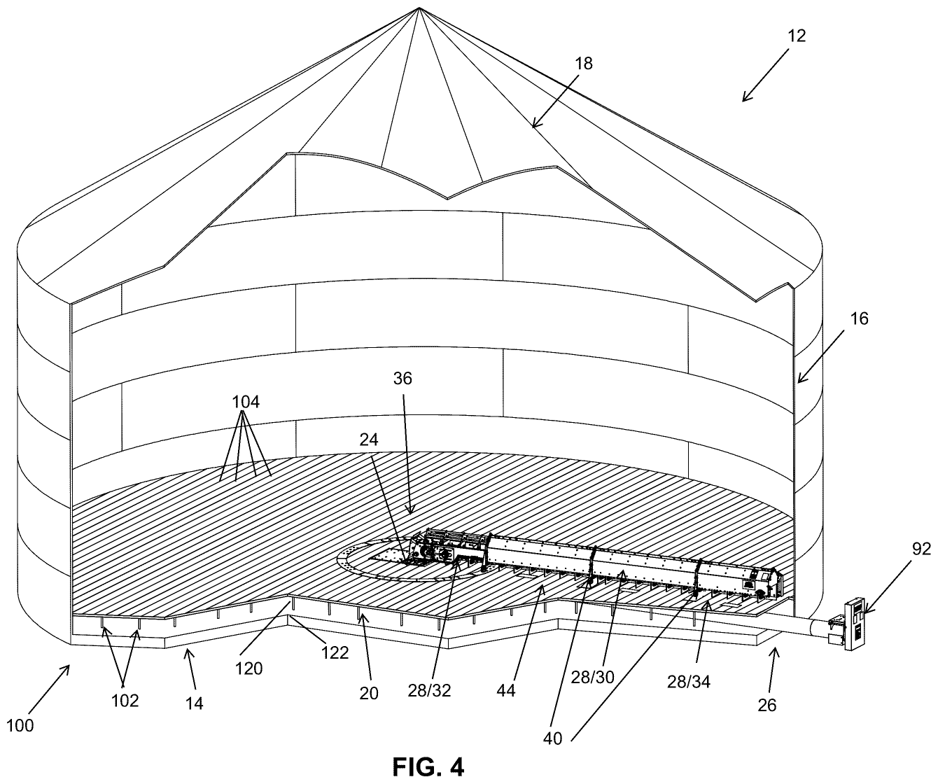

FIG. 5 shows a perspective cut-away elevation view of an exemplary aerated floor system, in accordance with one or more embodiments; the view showing an aerated floor system positioned on top of the floor support of an elevated floor.

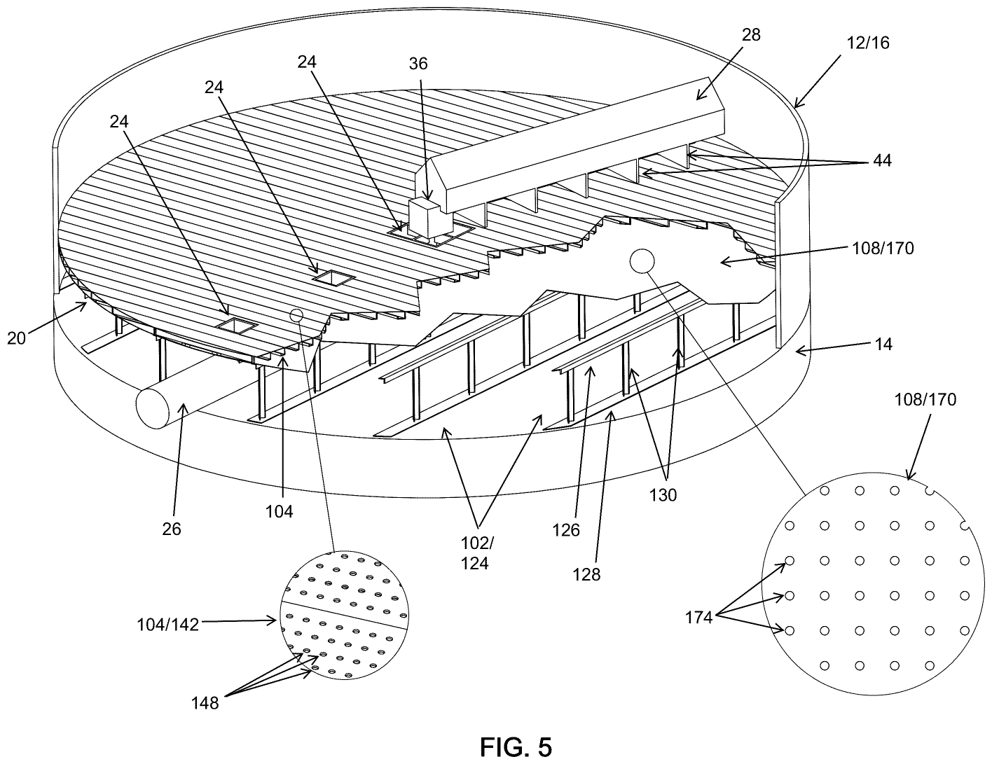

FIG. 6 shows an elevation view of a floor support used with an elevated aerated floor system, in accordance with one or more embodiments; the view showing the upper chord and lower chord of the floor support connected by web tie supports and located on a grain bin foundation.

FIG. 7 shows a an elevation view of a portion of an aerated floor system, in accordance with one or more embodiments; the aerated floor system having a plank assembly positioned on top of a perforated sheet with perforations to facilitate air flow; the view showing a zoomed in portion of the plank assembly.

FIG. 8 shows the zoomed in portion of the plank assembly shown in FIG. 7 with a layer of flour, dust and/or debris built up on top of a perforated sheet with perforations to facilitate air flow.

FIG. 9 shows a perspective exploded view of an aerated floor system, in accordance with one or more embodiments; the aerated floor system having a plank assembly and a perforated sheet with perforations to facilitate air flow.

FIG. 10 shows a perspective view of a plank assembly for an aerated floor system, in accordance with one or more embodiments; the plank assembly having flanges to keep the planks elevated and perforations to facilitate air flow.

FIG. 11 shows an elevation view of a plank assembly for an aerated floor system, in accordance with one or more embodiments; the plank assembly having flanges to keep the planks elevated and a filter located under a center wall of the plank.

FIG. 12 shows a perspective view of a grain bin floor, the grain bin floor having recesses in the foundation of the grain bin to allow air to flow under an aerated flow system; the view showing aerated floor system omitted.

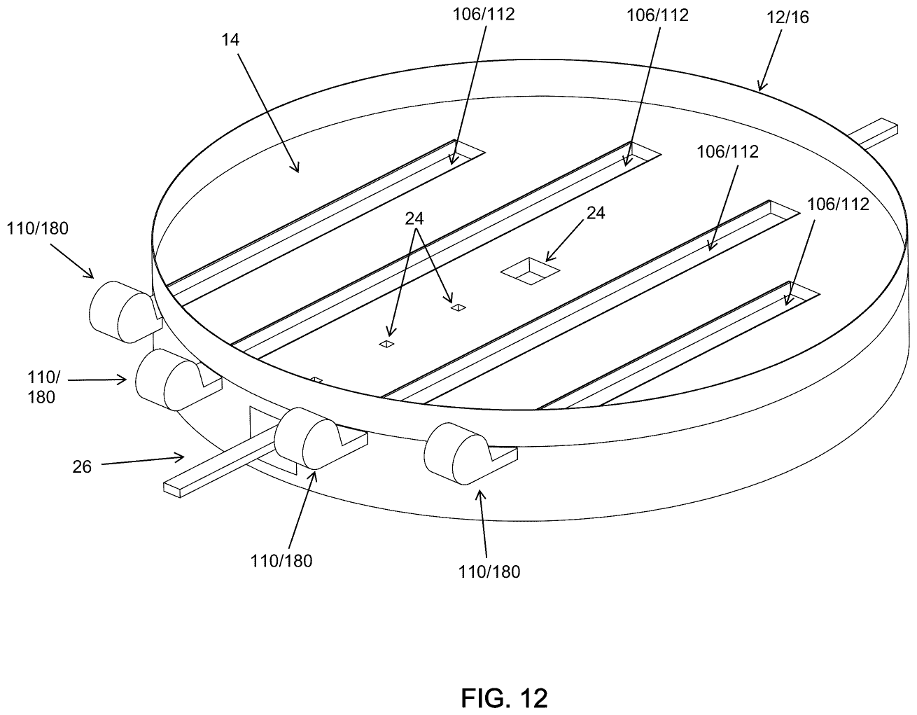

FIG. 13 shows a partial perspective view of an aerated floor system, in accordance with one or more arrangements, the aerated floor system positioned above floor supports located within the recesses of the foundation of a grain bin.

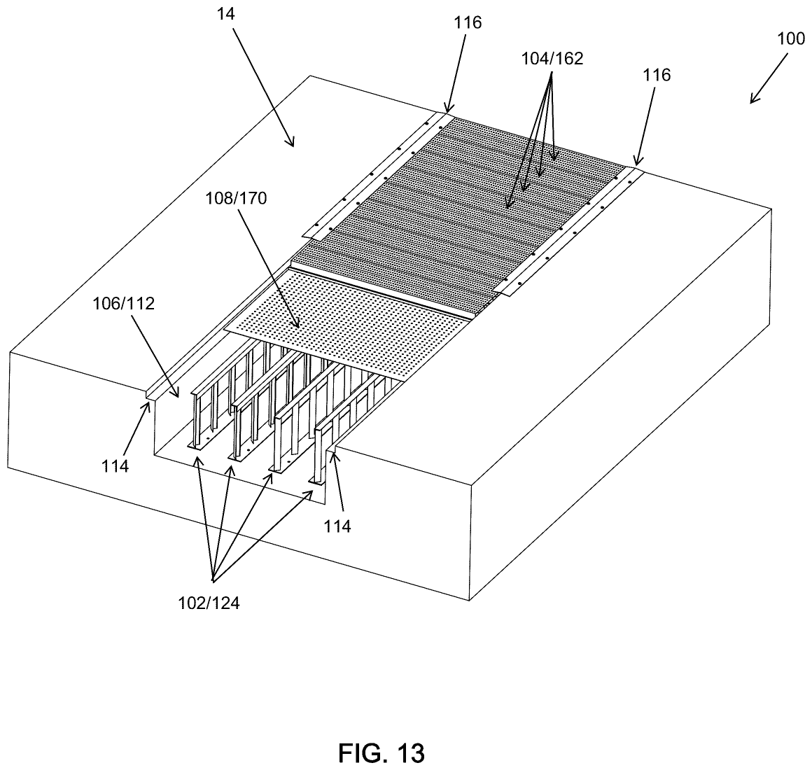

FIG. 14 shows an exploded view of an aerated floor system, in accordance with one or more arrangements; the view showing a plank assembly which is located above a filter and positioned above floor supports located within the recesses of the foundation of a grain bin.

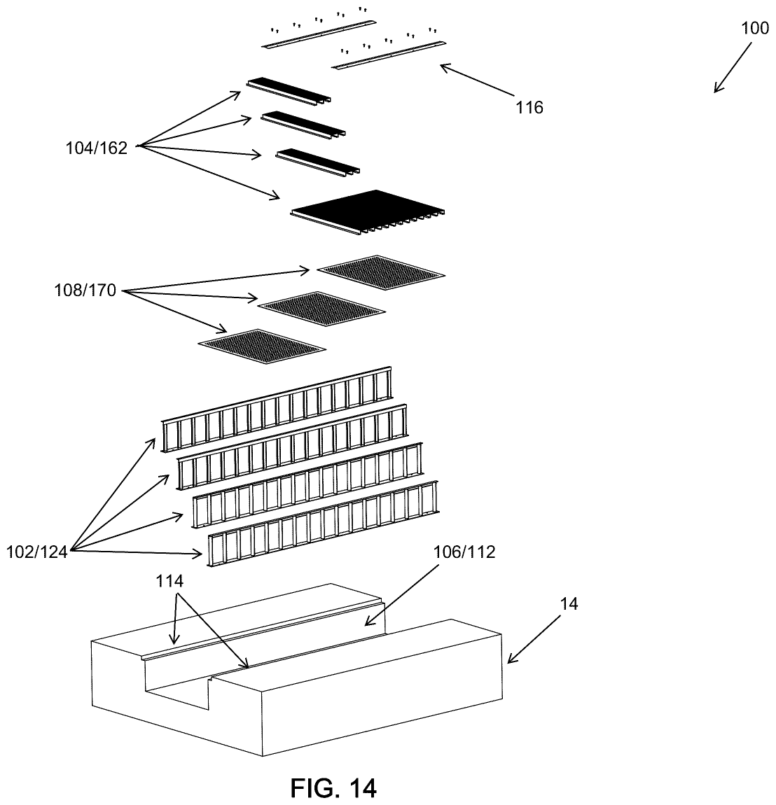

### DETAILED DESCRIPTION OF THE DISCLOSURE:

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc. ” is defined as “et cetera” and indicates the inclusion of all other elements belonging to the same group of the preceding items, in any “and/or”combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described as comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected or engaged, respectively, in any manner that facilitates operation, which may include being directly connected, indirectly connected, electronically connected, wirelessly connected, or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of grain bins. However, the embodiments are not so limited. It is appreciated that the embodiments may be adapted for use in other applications which may be improved by the disclosed structures, arrangements and/or methods. The system is merely shown and described as being used in the context of grain bins for ease of description and as one of countless examples.

With reference to the figures, an aerated floor system for grain bins 100, or flooring system 100, or simply system 100 is presented. In one or more arrangements, the system 100 is used in association with a grain bin 12 having a foundation 14, a sidewall 16, a peaked roof 18, a floor 20, a sump 24, a grain conveyor 26, and a sweep 28, among other components.

### Grain Bin 12

In the arrangement shown, an aerated floor system 100 is used in association with a grain bin 12. Grain bin 12 may be formed of any suitable size, shape, and design and is configured to hold a bulk amount of flowable material such as grain, granular materials, and/or other like materials. In the arrangement shown, as one example, grain bin 12 is a large, generally cylindrical structure that sits upon a foundation 14. Foundation 14 may be formed of any suitable size, shape, and design and is configured to provide support to grain bin 12. In the arrangement shown, as one example, foundation 14 is a circular or cylindrical concrete slab, however any other form of a foundation is hereby contemplated for use. In some various different arrangements, foundation 14 may operate as a floor 20 of the grain bin 12 (e.g., a non-elevated floor) or may support a floor 20 constructed thereon (e.g., an elevated floor). In the arrangement shown, as one example, foundation 14 also provides support for the lower end of sidewall 16.

In the arrangement shown, as one example, grain bin 12 has a sidewall 16. Sidewall 16 may be formed of any suitable size, shape, and design and is configured to enclose the contents of grain bin 12 and enclose the hollow interior of grain bin 12. In the arrangement shown, as one example, sidewall 16 is cylindrical in nature and is formed of a plurality of sheets of corrugated material that are connected to one another in end-to-end relation to form rings. These rings are stacked on top of one another to form the desired height of sidewall 16 of grain bin 12. However, any other form or configuration of a sidewall 16 is hereby contemplated for use. In the arrangement shown, as one example, the upper end of sidewall 16 provides support for peaked roof 18.

In the arrangement shown, as one example, grain bin 12 has a peaked roof 18. Peaked roof 18 may be formed of any suitable size, shape, and design and is configured to enclose the upper end of grain bin 12 and enclose the hollow interior of grain bin 12. In the arrangement shown, as one example, peaked roof 18 is formed of a plurality of panels that extend from the peak of the roof 18 downward and outward to the upper edge of sidewall 16. However, any other form or configuration of a roof 18 is hereby contemplated for use.

### Sump 24

In the arrangement shown, as one example, grain bin 12 includes at least one sump 24 formed in floor 20 of grain bin 12. Sump 24 is formed of any suitable size, shape, and design and is configured to selectively allow grain to pass through the floor 20 and into grain conveyor 26 that is positioned below floor 20, thereby allowing grain out of grain bin 12. In an example arrangement shown, as one example, grain bin 12 has a plurality of sumps 24 in floor 20, which are formed of an opening that is covered by a gate that selectively opens and closes by operation of a control mechanism (not shown) so as to facilitate grain to enter grain conveyor 26 positioned below sump 24.

### Grain Conveyor 26

In the arrangement shown, as one example, system 100 includes a grain conveyor 26. Grain conveyor 26 is formed of any suitable size, shape, and design and is configured to move grain out of grain bin 12, such as through a sump 24 or other opening in the elevated floor 20. In some various arrangements, grain conveyor 26 may be implemented using various grain movement devices including but not limited to, for example, an auger, a conveyor belt, a drag chain, and/or any other form of a grain movement device.

In some elevated floor arrangements, grain conveyor 26 is positioned below sump(s) 24 between foundation 14 and elevated floor 20. In a non-elevated floor arrangement, grain conveyor 26 is positioned below sump(s) 24 in a channel formed within foundation 14 and extending to an exterior of the grain bin 12. In an example elevated floor arrangement shown, as one example, grain conveyor 26 includes a cylindrical shaped housing forming a hollow interior extending from a center sump 24 to an output end. In this example arrangement, an auger or other grain movement device (e.g., a belt or drag chain) is positioned within the hollow interior. In one or more arrangements, auger includes a shaft with flighting configured to facilitate removal of grain from grain conveyor 26 as the shaft is rotated. In an arrangement shown, as one example, grain conveyor 26 is powered by a motor 92 operably connected to the shaft of the auger at an outward end of grain conveyor 26.

Motor 92 is formed of any suitable size, shape, and design and is configured to generate movement to drive grain conveyor 26. In some various arrangements, motor 92 may be implemented using various methods and/or means for generating movement including but not limited to, for example, an AC electric motor, a DC electric motor, pneumatic motor, hydraulic motor, combustion motor, and/or any other method or means for generating movement. When operated, motor 92 causes the rotation of auger, which facilitates the below-floor 20 transportation of grain from grain bin 12, from sumps 24, through hollow interior of housing to output end of grain conveyor 26.

### Sweep 28

In the arrangement shown, as one example, system 100 includes a sweep 28. Sweep 28 is formed of any suitable size, shape, and design and is configured to rotate around a pivot point 36, located in the center of grain bin 12, and move grain toward the center sump 24.

The system 100 includes a sweep 28 having an elongated body 30, a head section 32, a tail section 34, a pivot point 36, sweep supports 40, a pusher 42 (optional), a sweep mechanism 44, and an agitator 46, among other features, systems, and components as is described herein and shown in the figures.

In the arrangement shown, as one example, sweep 28 includes a sweep mechanism 44 positioned in elongated body 30 of sweep 28. Sweep mechanism 44 is formed of any suitable size, shape, and design and is configured to move grain along the length of elongated body 30 and into center sump 24. In the arrangement shown, as one example, sweep mechanism 44 is what is known as a paddle sweep, having a plurality paddles connected on to a chain that is rotated to move paddles on a lower side toward the inward end of the sweep 28 and paddles on an upper side toward the outward end of the sweep 28. In the arrangement shown, as one example, the links of the chain of sweep mechanism 44 wrap around and rotate upon a pair of sprockets positioned at the inward and outward ends of sweep 28. The sprockets may be toothed wheels, as is shown, or may be any other device that supports or facilitates rotation of another member such as a paddle sweep, a drag chain, a belt, a conveyor, and/or any other grain movement device.

While some arrangements may be primarily shown and/or described with reference to a paddle sweep type sweep mechanism 44, the arrangements are not so limited. Rather, it is contemplated that in some various arrangements, a sweep mechanism 44 may be configured to move grain toward center sump 24 using various methods and/or means including but not limited to, for example, a paddle sweep, a drag chain, a belt, an auger, and/or any other grain moving device.

In one or more arrangements, sweep 28 includes one or more pushers 42 (not shown) configured to rotate a drive wheel or track to facilitate movement of sweep 28. In the arrangement shown, as one example, pusher 42 includes a drive wheel 290 and is positioned near the outward end of sweep 28. Rather, it is contemplated that in some various arrangements, sweep 28 may utilize various different mechanisms to facilitate movement of sweep 28 when operated including but not limited to powered wheels, tracks, rails, pull chains, or any other mechanism to facilitate movement.

For additional information on sweeps, reference may be made to U.S. Pat. No. 11,708,227 titled SWEEP AUGER DRIVE SHIELD WITH GRAVITY RECLAIM, U.S. Pat. No. 11,337,374 titled SWEEP SYSTEM FOR FULL ELEVATED FLOOR GRAIN BINS, U.S. Publication No 2023/0172112 titles TRACK DRIVEN SWEEP SYSTEM FOR GRAIN BINS, each of which are hereby fully incorporated by reference herein.

However, the arrangements are not limited to the example sweep configurations discussed herein. Rather, it is contemplated that in some arrangements, aerated floor system 100 may be used in connection with any type of sweep or in grain bins without sweeps.

### Aerated Floor System 100

In one or more arrangements, as one example, aerated floor system 100 includes floor supports 102, planks 104, airflow passageway(s) 106 positioned below planks 104, filter 108, and a fan system 110.

### Floor Supports 102

In the arrangement shown, as one example, grain bin 12 includes a plurality of floor supports 102 for support of planks 104, which form an elevated floor 20 or which cover recesses 112 in foundation 14 that form airflow passageways 106 for a non-elevated floor 20.

Floor supports 102 are formed of any suitable size, shape, and design and are configured to provide support for planks 104 floor 20 as well as facilitate airflow under planks 104. In one or more arrangements, floor supports 102 have an elongated shape extending vertically from an upper end 120, where floor supports 102 connect with elevated floor 20, to a lower end 122, where floor supports 102 connect with foundation 14.

In some various arrangements, floor supports 102 may be implemented using elongated members of various shaped tubes, stock, beams, and/or other elongated members including but not limited to, tubing, beams (e.g., I-beams, H-beams T-beams, and/or any other type of beam), C-shaped channels, bars, rods, angle stock, or any other elongated tubes, stock, and/or other elongated members.

However, the arrangements are not so limited. Rather, it is contemplated that in some arrangements, floor supports 102 may include a structure or assembly formed of multiple interconnected components. For example, in one or more arrangements, as is shown, floor supports 102 are trusses 124, which may facilitate easier and/or quicker installation. In an arrangement shown, as one example, trusses 124 have an elongated rectangular shape formed by an upper cord 126 and a lower cord 128 extending a length of trusses 124 and a plurality of web tie supports 130 extending between upper cord 126 and lower cord 128. In the arrangement shown, web tie supports 130 of trusses 124 extend vertically between upper cord 126 and lower cord 128. However, the arrangements are not so limited. Rather, it is contemplated that in some various arrangements, trusses 124 additionally or alternatively have web tie supports 130, upper cord 126, and/or lower cord 128 in various other angles and/or arrangements.

In some various arrangements, floor supports 102 / trusses 124 may be connected with foundation 14 and/or elevated floor 20 formed by planks 104 using various means and/or methods including but not limited to, for example, screwing, nailing, bolting, riveting, welding, gluing, affixing, locking, friction fitting, threading, and/or forming the components out of a single piece of material such as stamping, machining, molding, casting, and/or by any other manner or method or the like.

### Planks 104

Planks 104 are formed of any suitable size, shape, and design and are configured to connect with one another to form a portion of floor 20 in a grain bin 12, support a mass of grain within grain bin 12 thereon, and facilitate movement of air upward through the planks 104 and into the grain.

In one or more arrangements shown, as one example, planks 104 are installed over support members 102 in grain bin 12 to form an elevated floor 20 extending across foundation 14 within grain bin 12. In one or more other arrangements shown, as one example, planks 104 are installed over support members 102 positioned in recesses 112 of foundation 14 that operate as airflow passageways 106 to cover the recesses 112 and form a portion of a non-elevated floor 20 in the grain bin 12. In these arrangements, planks 104 rests upon the upper surface of floor supports 102 and establishes a generally planar upper surface of elevated or non-elevated floor 20.

In one or more arrangements, as is shown, planks 104 have a generally rectangular elongated shape extending a length in a generally straight manner between opposing ends 140. In the arrangement shown, as one example, planks 104 include a center wall 142 that extends horizontally between a front edge 146 and a rear edge 144 and the opposing ends 140 of the planks 104. In one arrangement, the center wall 142 has a plurality of openings or perforations 148 therein that are large enough to allow air flow through the floor 20 but not so large that grain can fall through the perforations. This center wall 142 connects at its front edge 146 and rear edge 144 to sidewalls 152 which extend downward therefrom.

The sidewalls 152 are generally flat and planar in shape and extend downward from the outward edges of the center wall 142 in approximate parallel spaced alignment to one another and form a channel at their lower ends that facilitate nesting with adjacent planks 104. In one or more arrangements, as is shown, flanges 154 extend horizontally to the side from the lower ends of sidewalls 152 which form a base for planks 104 to contacts and rests on floor supports 102 or other supporting component. In one or more arrangements, a second set of flanges 156 extend upward from an outward end of flanges 154. In one or more arrangements, flanges 156, flanges 154, and sidewalls 152 connected thereto form an upward facing channel 158 configured to receive and nest with flange 156, flange 154, and sidewall 152 of an adjacent plank 104 to facilitate interconnection of planks 104. In the arrangement shown, as one example, planks 104 nest in side-to-side alignment with one another and rest upon floor supports 102 to form floor 20. Any other shape or configuration is hereby contemplated for use for planks 104. In the arrangement shown, the combination of bends and shapes that form planks 104 provides strength and rigidity to planks 104 in much the same way that corrugation provides strength and rigidity to a sheet of sheet metal.

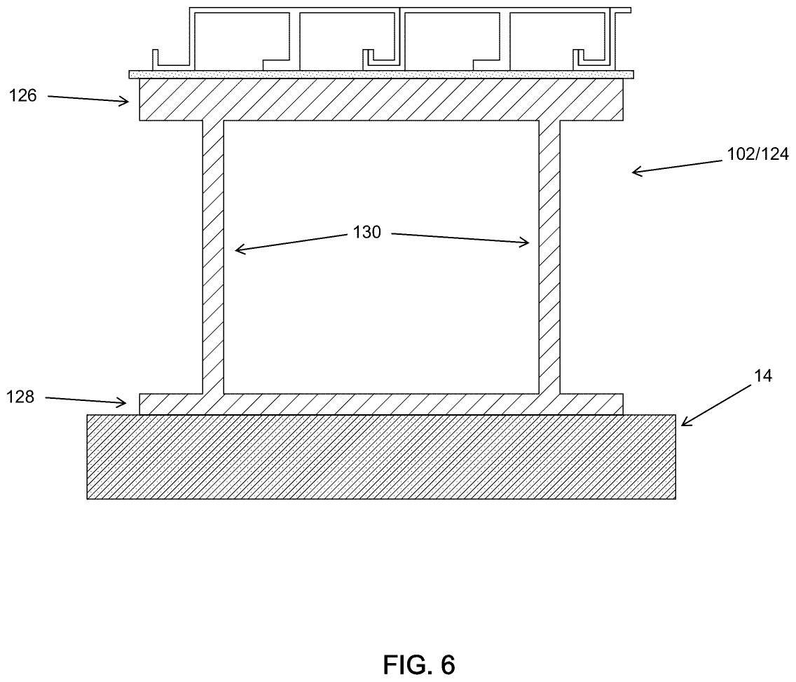

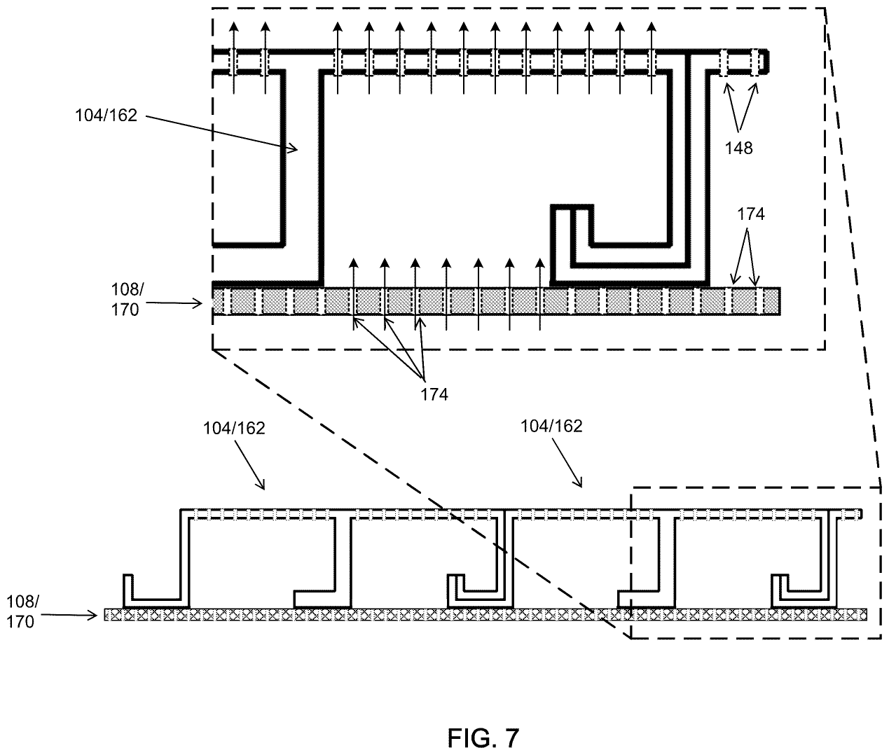

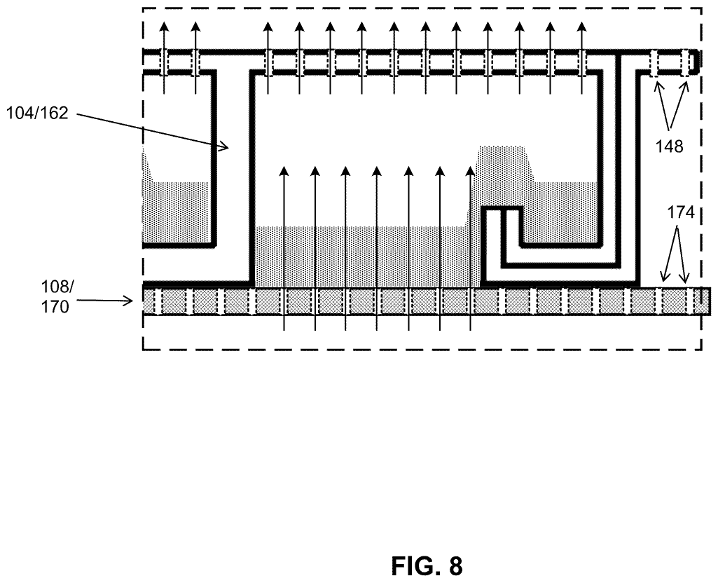

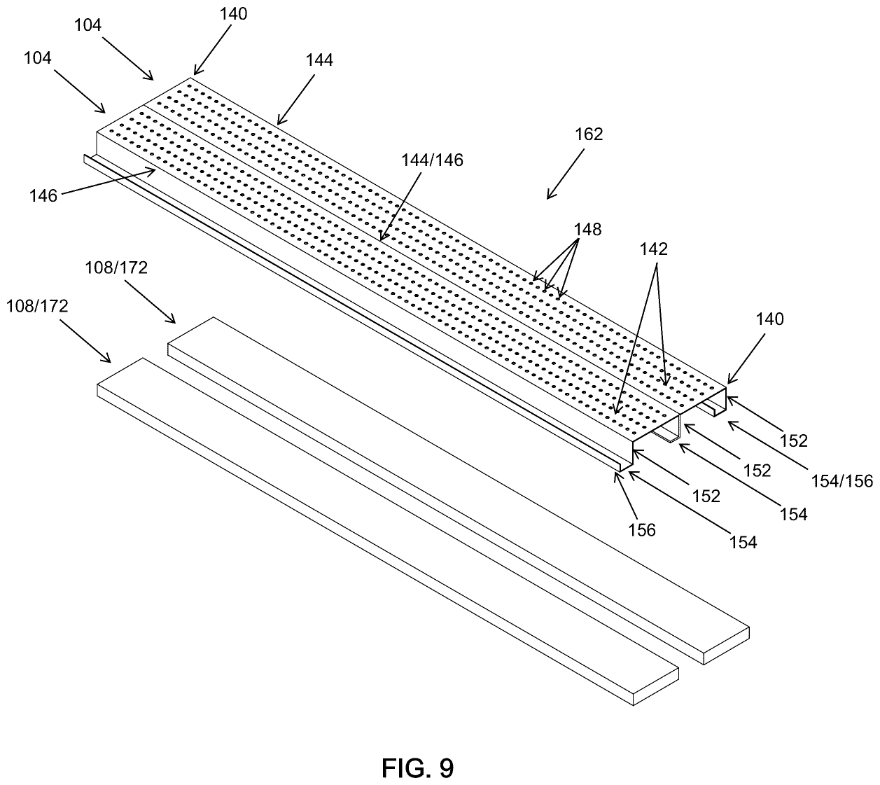

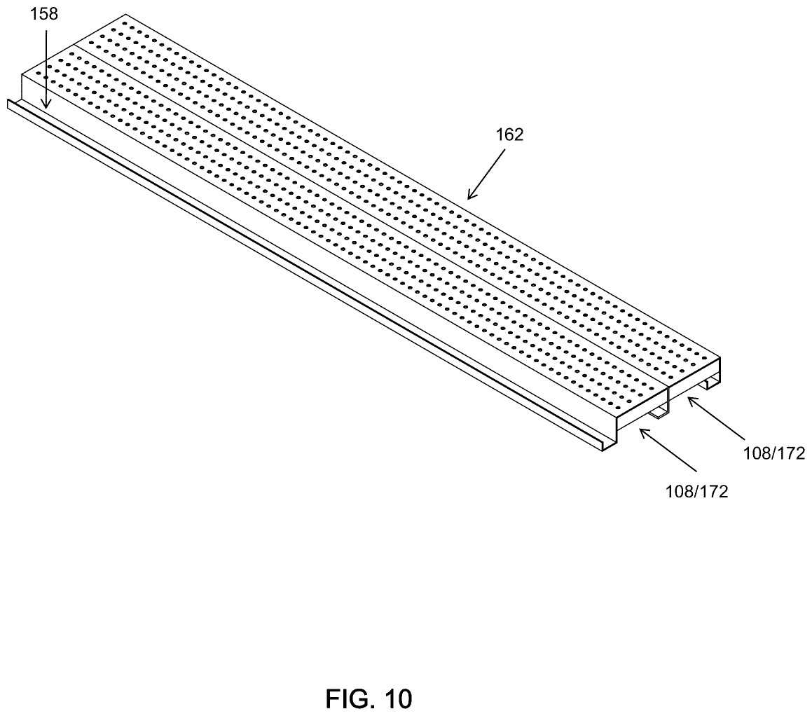

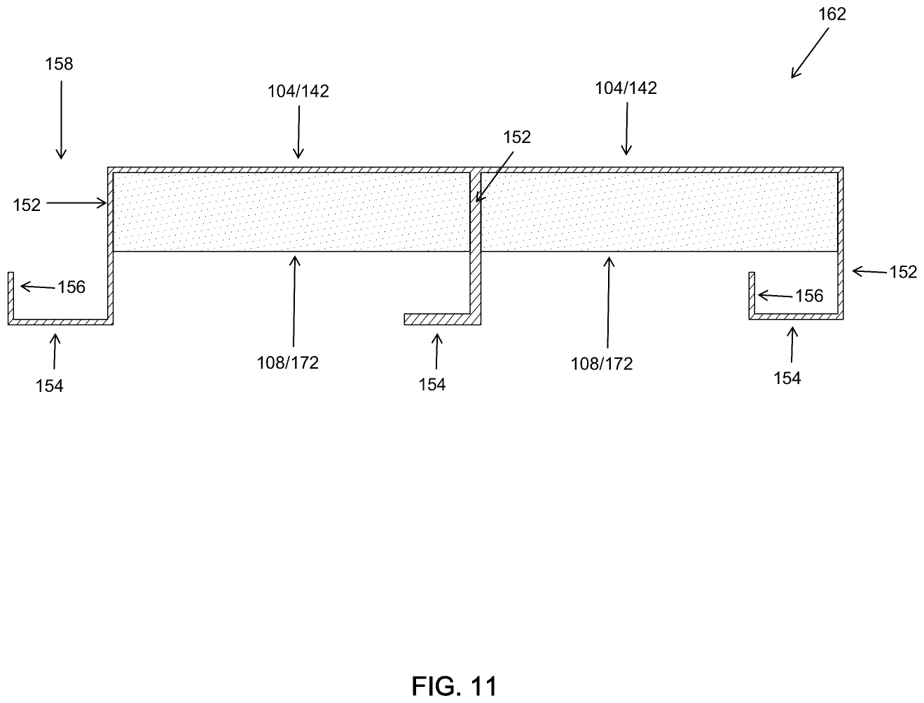

In some arrangements two or more planks 104 may be pre-attached to one another to form a plank assembly 162 for easier transportation and/or installation as a single unit, for example as shown in FIGS. 6-11. Planks 104 may be connected to form plank assemblies using various means and/or methods including but not limited to, for example, screwing, nailing, bolting, riveting, welding, gluing, affixing, locking, friction fitting, threading, crimping, clamping, and/or forming the components out of a single piece of material such as stamping, machining, molding, casting, and/or by any other manner or method or the like.

### Airflow Passageway(s) 106

Airflow passageways 106 are formed of any suitable size, shape, and design, and are configured to deliver an airflow to an underside of planks 104, where it is pushed upward through perforations 148 in planks 104 and into and through grain in grain bin 12. As one example, in the elevated floor context, the space between elevated floor 20 and foundation 14 form an airflow passageway 106 for blowing of air up through planks 104. The space between elevated floor 20 and foundation 14 also allows room for other components of the system 100 such as sump 24 and grain conveyor 26.

As another example, in the non-elevated floor context, recesses 112 in the foundation 14 operated as airflow passageways 106 to deliver and push air up through perforations 148 of planks 104. In one or more arrangements as is shown, planks 104 rest on and extend between ledges 114 formed on each side of recesses 112. In one or more arrangements, fastener strips 116 are installed over ends 140 of planks 104 along upper edges of recesses 112 to secure planks 104 with foundation 14. In one or more arrangements, as is shown, planks 104 may additionally or alternatively rest on floor supports 102 and/or trusses 124 positioned within recesses 112. In some various arrangements, fastener strips 116, planks 104, foundation 14, and/or floor supports 102/trusses 124 may be interconnected using various means and/or methods including but not limited to, for example, screwing, nailing, bolting, riveting, welding, gluing, affixing, locking, friction fitting, threading, crimping, clamping, and/or by any other manner or method or the like. However, the arrangements are not limited to these example airflow passageways 106.

Rather, it is contemplated that in some various different arrangements may utilize additional or alternative airflow passageways to move air up through planks 104 and into and through grain in grain bin 12. For instance, in some arrangements, airflow passageways 106 may utilize a system of ventilation ducts to deliver airflow.

### Filter 108

Filter 108 is formed of any suitable size, shape, and design, and is configured to inhibit flour, dust, and debris that fall through perforations 148 of planks 104 from entering airflow passageways 106 while permitting air to flow from the airflow passageways 106 to perforations 148 in planks 104. By inhibiting such flour, dust, and debris from entering airflow passageways 106 the length of time before airflow passageways 106 become blocked and need cleaning can be significantly increased. In one or more arrangements, filter 108 includes one or more perforated sheets 170 positioned below planks 104, which operate to catch flour, dust, and debris while permitting air to flow up through perforations 174 in sheet 170 and through perforations 148 in planks 104.

By conventional thinking, one might expect the smaller area between filter 108 and planks 104 to fill and block airflow more quickly than it would ordinarily take for the larger airflow passageways 106 become blocked. However, although flour, dust, and debris will eventually build up and fill the space between filter 108 and planks 104, it has been surprisingly discovered that ventilation fans for a grain bin 12 can still push air up through the filter 108 and the through built up flour, dust, and debris. Without subscribing to any particular theory of operation, it is believed that built up flour, dust, and debris must reach a critical thickness before airflow through floor 20 is prevented. By positioning filter 108 in fairly close proximity to planks 104, the maximum thickness of built up flour, dust, and debris is limited to the thickness at which built up flour, dust, and debris reaches and fills the perforations 148 of planks 104. At which point, no more flour, dust, and debris can fall into perforations 148 and further build up. It is further suspected that due to the nature and structure of crushed grain particles, built up flour, dust, and debris acts as a non-Newtonian fluid such that pressure forcing additional built up flour, dust, and debris into perforations 148 of planks 104, causes the built up flour, dust, and debris to become rigid/solid and prevents the built up flour, dust, and debris from being pushed through perforations/holes in filter 108. In this manner, airflow passageways 106 are prevented from building up with flour, dust, and debris.

In addition to or as an alternative to perforated sheet(s) 170, in some various arrangements, filter 108 may utilize various methods and/or means to catch flour, dust, and debris including but not limited to various sheets, screens, textiles, fiberglass, foams, membranes, as one example alternative, in one or more arrangements, filter 108 may be implemented by a length of foam 172 or other material that is positioned between sidewalls 152 of planks 104 below center wall 142. As another example, filter 108 may be implemented by a length of textile or other filter material that is adhered to a bottom surface of center wall 142 of planks 104.

### Fan System 110

Fan system 110 is formed of any suitable size, shape, and design and is configured to blow air into airflow passageways 106 with sufficient pressure so as to cause air to flow up through planks 104 of floor 20 and into and through grain in grain bin 12. In the arrangement shown, as one example, fan system 110 includes one or more motorized fans 180 positioned on the exterior grain bin 12 with fluidic connection from fans into airflow passageway(s) 106. However, the arrangements are not so limited to the arrangements of fans 180 shown herein. Rather, it is envisioned that in some various arrangements, fan system 110 may utilize various different arrangements and/or positioning of fans.

From the above discussion it will be appreciated that the aerated floor system 100 for grain bins improves upon the state of the art. More specifically, and without limitation, it will be appreciated that in one or more arrangements, an aerated floor system 100 for grain bins is provided: that reduces or eliminates the build-up of flour, dust, and/or debris in airflow passageways 106 below an aerated floor of a grain bin; that provides an aerated floor system for grain bins that works effectively; requires less frequent cleaning; that is durable; that can be used with all kinds of grain; that has a long useful life; that can be used with sweep systems; and/or that can be used with paddle sweeps, auger sweeps, or any other configuration of a sweep, among countless other advantages and improvements.

It will be appreciated by those skilled in the art that other various modifications could be made to the device without parting from the spirit and scope of this disclosure. All such modifications and changes fall within the scope of the claims and are intended to be covered thereby.

What is claimed

1. An aerated floor system for grain bins, comprising:
a plurality of planks positioned above one or more airflow passageways;
the plurality of planks having a plurality of perforations to facilitate the flow of air through the plurality of planks;
one or more filters positioned below the plurality of planks;
the one or more filters configured to catch flour, dust, and/or debris that fall through the plurality of perforations of the plurality of planks while permitting air to be moved upward through the one or more filters and the plurality of planks, thereby reducing the build-up of the flour, dust, and/or debris in the one or more airflow passageways.

2. The aerated floor system of claim 1, wherein the one or more filters include one or more perforated sheets.

3. The aerated floor system of claim 1, wherein the one or more filters include one or more screens.

4. The aerated floor system of claim 1, wherein the one or more filters include one or more layers of foam.

5. The aerated floor system of claim 1, wherein the one or more filters include one or more textile layers.

6. The aerated floor system of claim 1, wherein the one or more filters are adhered to a bottom surface of a perforated portion of the planks.

7. The aerated floor system of claim 1, further comprising a fan system;
the fan system configured to direct air into the one or more airflow passageways and thereby move air upward through the one or more filters, any flour, dust, and/or debris built-up on the one or more filters, and the plurality of planks.

8. The aerated floor system of claim 1, further comprising a fan system;
the fan system configured to direct air into the one or more airflow passageways and thereby move air upward through the one or more filters, the plurality of planks, and a layer of the flour, dust, and/or debris built-up on the one or more filters up to a threshold thickness;
wherein the one or more filters are positioned a distance from the plurality of planks that is less than the threshold thickness, thereby preventing the flow of air from becoming blocked by a layer of flour, dust, and/or debris.

9. The aerated floor system of claim 1, wherein the plurality of planks form an elevated floor positioned a distance above a foundation of the grain bin.

10. The aerated floor system of claim 1, wherein the plurality of planks form part of a non-elevated floor.

11. The aerated floor system of claim 1, wherein the grain bin has a foundation with one or more recesses forming the one or more airflow passageways;
wherein the plurality of planks cover the one or more recesses and form a portion of a non-elevated floor.

12. The aerated floor system of claim 1, wherein the one or more filters are adhered to a bottom surface of a perforated portion of the planks.

13. An aerated floor system for grain bins, comprising:
a plurality of planks positioned above one or more airflow passageways;
the plurality of planks having a plurality of perforations to facilitate the flow of air through the plurality of planks;
one or more filters positioned below the plurality of planks;
the one or more filters configured to catch flour, dust, and/or debris that fall through the plurality of perforations of the plurality of planks while permitting air to be moved upward through the one or more filters and the plurality of planks, thereby reduce the build-up of the flour, dust, and/or debris in the one or more airflow passageways;
a fan system;
the fan system configured to direct air into the one or more airflow passageways and thereby move air upward through the one or more filters, any of the flour, dust, and/or debris built-up on the one or more filters, and the plurality of planks;
wherein the fan system is capable of moving air upward through the one or more filters, the plurality of planks, and a layer of the flour, dust, and/or debris built-up on the one or more filters up to a threshold thickness;
wherein the one or more filters are positioned a distance from the plurality of planks such that the thickness that the layer of flour, dust, and/or debris can built-up on the one or more filters is limited to a maximum thickness;
wherein the maximum thickness is less than the threshold thickness, thereby preventing the flow of air from becoming blocked by the layer of flour, dust, and/or debris.

14. The aerated floor system of claim 13, wherein the plurality of planks form an elevated floor positioned a distance above a foundation of the grain bin.

15. The aerated floor system of claim 13, wherein the plurality of planks form a portion of a non-elevated floor.

16. The aerated floor system of claim 13, wherein the grain bin has a foundation with one or more recesses forming the one or more airflow passageways;
wherein the plurality of planks cover the one or more recesses and form part of a non-elevated floor.

17. The aerated floor system of claim 13, wherein the one or more filters include one or more perforated sheets.

18. The aerated floor system of claim 13, wherein the one or more filters include one or more screens.

19. The aerated floor system of claim 13, wherein the one or more filters include one or more layers of foam.

20. The aerated floor system of claim 13, wherein the one or more filters include one or more textile layers.

21. The aerated floor system of claim 13, wherein the one or more filters are adhered to a bottom surface of a perforated portion of the plurality of planks.
